(19) United States
(12) Patent Application Publication
(10) Pub. No.: US 2025/0055735 A1
(43) Pub. Date: Feb. 13, 2025

(54) REDUCED STATE MLSE DECODING

(71) Applicant: Microchip Technology Incorporated, Chandler, AZ (US)

(72) Inventor: Peter Graumann, Calgary (CA)

(21) Appl. No.: 18/799,740

(22) Filed: Aug. 9, 2024

Related U.S. Application Data
(60) Provisional application No. 63/518,505, filed on Aug. 9, 2023.

(51) Int. Cl. H04L 25/49; H04L 25/03

(52) U.S. Cl. CPC H04L 25/4917; H04L 25/03057; H04L 25/03178

(57) ABSTRACT

A method may include: initializing four states of a trellis, the four states corresponding to the four possible symbol levels in PAM4, where a respective initial state starts with an initial score and an empty survivor path; for respective possible transitions between the four initial states and four possible current states of the trellis, determining expected PAM4 symbols; determining error associated with respective transitions based on differences between a received PAM4 symbol and the expected PAM4 symbols; discarding transitions where the error indicates a difference greater than a single signal level, and keep the other transitions; and for respective current state groups of a two state trellis, determining one of the incoming transitions that was not discarded having the highest likelihood of being associated with a transmitted symbol.

### CROSS-REFERENCE TO RELATED APPLICATION

This application claims the benefit under 35 U.S.C. § 119 (e) of U.S. Provisional Patent Application Ser. No. 63/518,505, filed Aug. 9, 2023, the disclosure of which is hereby incorporated herein in its entirety by this reference.

### FIELD

Examples relate to signal processing and decoding signals encoding using quaternary signaling techniques. Some examples relate to reduced complexity Maximal Likelihood Sequence Estimation techniques for signal processing and decoding signals.

### BACKGROUND

Various signaling techniques are used in normal and high-speed serial communication systems. Examples include binary signaling techniques such as Pulse Amplitude Modulation 2 (PAM2), and quaternary signaling techniques, such as PAM4.

### BRIEF DESCRIPTION OF THE DRAWINGS

To easily identify the discussion of any particular element or act, the most significant digit or digits in a reference number refer to the figure number in which that element is first introduced.

FIG. 1 is a diagram of a reduced trellis structure in accordance with one or more examples.

FIG. 2 is a diagram depicting a process to evaluate received PAM4 symbols and how the states of the trellis structure are reduced to a 2:2 configuration, in accordance with one or more examples.

FIG. 3 illustrates an example process to evaluate received PAM4 symbols utilizing reduced state trellis, in accordance with one or more examples.

FIG. 4 illustrates an example process to evaluate received PAM4 symbols utilizing reduced state trellis, in accordance with one or more examples.

FIG. 5 illustrates an example process for scoring used to determine the best transitions based on cumulative error scores, in accordance with one or more examples.

FIG. 6 is a block diagram depicting a signal processing chain of a decoder, in accordance with one or more examples.

FIG. 7 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples that may be practiced in accordance with this disclosure. Examples are described in sufficient detail to enable a person having ordinary skill in the art to practice the various examples. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the examples discussed herein. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of the examples or this disclosure to the specified components, steps, acts, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including, without limitation, a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code, without limitation) related to examples described herein.

Examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

### BACKGROUND

A convolutional coder is a finite state machine (FSM) with a limited amount of state. A convolutional coder produces output bits that are various functions of input bits and the state. After the output bits are produced, the FSM transitions to a new state based on the input bits and the previous state. A decoder considers a received sequence of bits and determines an input sequence of bits that best (most likely) explains the received sequence of bits (stated another way, determines the input sequence of bits that most likely produced the received sequence of bits).

A trellis is a graphical representation of the FSM of the convolutional coder that illustrates the state transitions of the convolutional coder over time. The trellis includes a first set of nodes (depicted as circles) that represent possible states at a current time step, a second set of nodes that represent possible states at a next time step, and arcs (depicted as arrows) that connect nodes in the first set to nodes in the second set. Each node represents a specific state (e.g., identified by a number). Each arc represents a valid transition from one state to another state. Using a trellis representative of the convolutional coder, a decoder only has to consider the finite number of possible states, and the most likely sequence that led to that state, using an algorithm such as the Viterbi algorithm.

A convolutional coder can be used by a transmitter to produce encoded output bits that are a function of a current input bit and one or more previous input bits that set the coder's current state. This effectively spreads the information of an input bit (the current input bit) over several output bits, which increases redundancy and the ability of a receiver to detect and correct errors that may occur during transmission. The redundancy introduced by convolutional encoding allows a transmitted signal to be more resilient to the impairments of the channel, such as noise, insertion loss, and interference. The encoded output bits may be modulated onto a carrier using a modulation scheme, i.e., encoded output bits are mapped to physical symbols that are transmitted on a physical medium (the transmitted symbols).

Trellis-Coded Modulation (TCM) is a modulation technique for producing a transmitted sequence of symbols by integrating convolutional encoding with modulation. A symbol group is produced that is mapped based on an input sequence of bits and the state of a convolutional coder. The state of the convolutional coder transitions to a new state based on the previous state and some or a totality of the bits of the input sequence of bits. A logical or functional block that performs TCM may also be referred to herein as a “convolutional trellis.”

Pulse amplitude modulation (PAM) is a modulation technique that encodes data by varying amplitude of electrical pulses using multiple distinct signal levels.

In binary signaling techniques, such as PAM2 or non-return to zero (NRZ), two voltage levels represent a symbol, and each symbol may represent 1 bit of data. For example, a first voltage level of a PAM2 symbol may represent a ‘0’ and second, different voltage level of a PAM2 symbol may represent a ‘1.’

PAM4 is a signaling technique typically used to transmit data over high-speed serial communication links, such as high-speed Serializer/Deserializer (SerDes) communication systems (“high-speed SerDes”) found in high-speed communication systems such as data centers, networking equipment, and high-speed interfaces such as PCIe (Peripheral Component Interconnect Express) and USB (Universal Serial Bus).

PAM4 uses four voltage levels to represent a symbol. A PAM4 symbol may encode 2 bits of data, which allows higher data rates (e.g., as compared to PAM2 signaling) without the need for increasing the signaling frequency. The voltage levels in PAM4 are typically represented as −3, −1, +1, and +3 (or 1, −⅓, +1,3, +1) or a similar combination. For symbol recovery, a decoder determines the amplitude of the incoming signal (signal level) and maps the determined signal level to data.

Using PAM4, a SerDes can transmit 2 bits of data per symbol, effectively doubling the data rate compared to binary signaling techniques. However, PAM4 signaling is more complex than PAM2 and sensitive to noise, channel impairments, and inter-symbol interference (ISI) that are found in high-speed SerDes channels. So, sophisticated equalization and signal processing techniques are used to achieve reliable communication at high data rates, for example, to achieve target symbol error rates (SER) expected in high-speed SerDes, without limitation. Despite its challenges, PAM4 has become widely adopted in modern high-speed communication interfaces to meet the increasing demand for higher data transfer rates while maintaining a manageable level of complexity and power consumption.

PAM4 can be thought of as running four SerDes in parallel, at least in terms of its data rate efficiency. When using traditional binary signaling (PAM2 or NRZ), each symbol represents one bit of data, and the signaling rate is equivalent to the data rate. However, PAM4, as mentioned earlier, encodes two bits of data per symbol by using four voltage levels. By transmitting two bits per symbol, PAM4 effectively doubles the data rate compared to traditional binary signaling, all while operating at the same signaling rate. In this sense, you can consider PAM4 as achieving the same data rate efficiency as running four independent SerDes lanes operating at the lower signaling rate used in PAM2.

When a PAM4 signal is transmitted through a communication channel, it can experience various forms of distortion, leading to the possibility of errors during data recovery. ISI is a form of distortion that occurs when the symbols from neighboring bits interfere with each other due to channel characteristics, which can cause confusion during decoding.

Decision Feedback Equalization (DFE) is a technique used in SerDes decoders to combat the various forms of distortion that occur in high-speed SerDes channels.

Decision Feedback Equalization (DFE) is a signal processing technique used at the receiver end of a communication link, especially in SerDes decoders, to mitigate intersymbol interference (ISI) and other distortions in high-speed communication links. DFE operates based on feedback: decisions made by the decoder for previous symbols are used to reduce (e.g., cancel out, without limitation) ISI for the current symbol.

By way of example of a DFE process: a received signal is sampled, and a preliminary decision is made about a current transmitted symbol (a “symbol decision”) based on the sampled signal. This preliminary decision may be affected by ISI from previously transmitted symbols. The decoder uses the decisions from previously decoded symbols to estimate their ISI contributions to the received signal. These estimated contributions are subtracted from the current sample to cancel or reduce ISI. The decoder then makes a more accurate decision about the current transmitted symbol. The decoder continues to use this process, with feedback information improving the accuracy of subsequent symbol decisions, thereby enhancing overall data recovery.

DFE is used in PAM4 receivers to recover transmitted data from the received signal. In some channels, DFE alone is sufficient to suitably mitigate ISI and recover the transmitted data accurately. However, as the channel becomes more challenging, especially with higher insertion loss, DFE may become insufficient.

For such difficult channels, Maximal Likelihood Sequence Estimation (MLSE) is sometimes used instead of DFE. MLSE is a signal processing technique that can provide a more robust solution than DFE by considering multiple symbol sequences and selects the one it determines has the highest likelihood of being the transmitted sequence, thus better handling of severe ISI and channel impairments. MLSE evaluates these sequences by considering the received signal, channel characteristics, and statistical properties of the transmission.

In general, MLSE can provide 1-2 decades of improvement in receiver SER compared to DFE, but at a significant cost in terms of implementation area and power consumption. The MLSE algorithm is computationally intensive and requires knowledge of the channel characteristics, noise statistics, and the modulation scheme used. It often employs the Viterbi algorithm or other optimization methods to efficiently explore the vast number of possible symbol sequences and determine the most probable one.

In PAM4, MLSE is applied at the PAM4 receiver to decode the received signal and recover the transmitted PAM4 symbols. It addresses the effects of noise, channel impairments, and inter-symbol interference (ISI) that are common in high-speed communication channels.

An MLSE algorithm uses channel state information (CSI) to find the most likely transmitted symbol or sequence of symbols given a received signal. CSI is information about the characteristics and/or condition of a communication channel via which a signal is transmitted. CSI may be determined or pre-determined, and may include one or more of:
Signal-to-Noise Ratio (SNR): The ratio of the signal power to the noise power in the received signal.
Channel Response: The frequency response of the channel, which indicates how the channel affects different frequency components of the transmitted signal.
Impulse Response: The time-domain response of the channel, indicating how the channel introduces delays and distortions to the transmitted signal.
Channel Memory: The extent to which the channel retains information about past transmitted symbols, which influences ISI.
Modulation Scheme: The type of modulation used, which affects the mapping of symbols to signal points.

MLSE can incorporate DFE tap values as part of its CSI. DFE taps are coefficients used to adjust feedback in a DFE equalizer, helping to cancel ISI caused by the communication channel. DFE taps control how much of the previously detected symbols are subtracted from the current sample to remove ISI. These taps (e.g., the values of the coefficients of the taps, without limitation) may be dynamically adjusted, including during an equalization process, to enhance performance based on channel conditions. In MLSE, DFE tap values (which represent the feedback coefficients that control the taps, and thus the amount of feedback being applied) may be used as parameters when determining the most likely transmitted sequence.

Traditional PAM4 MLSE uses a 4:4 trellis structure to track and decode the transmitted symbols. The 4:4 trellis structure maintains four distinct states representing the four possible PAM4 signal levels (0, 1, 2, 3), considering 16 transitions (4 possible transitions per state). Each state corresponds to a specific level of the received signal, and MLSE keeps track of the possible transitions between these states over time.

MLSE uses the trellis structure to decode the received PAM4 symbols accurately. The four states represent the four possible values that a transmitted symbol can take. At each symbol interval, the receiver must decide which of the four possible states the received symbol corresponds to. At each symbol interval, each state can transition to any of the four states, resulting in 16 possible transitions (4 previous states×4 current states). This decision is based on minimizing the accumulated error (or distance) from the expected signal pattern.

Each state transition has an associated score based on how well the received signal matches the expected signal for that transition. The survivor path is the sequence of previous states that led to the current state with the minimum cumulative error.

The trellis structure helps the receiver handle ISI and noise by considering all possible sequences of states (paths) that could lead to the current received symbol. By evaluating the cumulative error along these paths, the MLSE can determine the most likely sequence of transmitted symbols that resulted in the observed received signal. In traditional MLSE, the MLSE algorithm evaluates all 16 possible transitions and updates the scores and survivor paths for each state. The state with the lowest cumulative score at the current symbol interval is considered the most likely state, and its survivor path represents the most likely sequence of transmitted symbols.

As data rates increase (e.g., 112 Gbps, 128 Gbps, 224 Gbps), MLSE becomes more important for reducing symbol error rate (SER). However, traditional MLSE implementations are resource-intensive, requiring significant area, power, and introducing high latency. This invention aims to reduce the complexity, area, and power consumption while maintaining similar performance.

The inventors of this disclosure appreciate that in high-speed PAM4 SerDes, errors rarely exceed one level, thus, the state space may be reduced to a 2:2 trellis.

One or more examples relate, generally, to a PAM4 MLSE algorithm or PAM4 receiver that combines states into two groups: even state (0 or 2) or odd state (1 or 3), which reduces the number of states in the state space to 2 states, and the number of transitions that must be considered at the next symbol interval to 8 transitions. This effectively halves the complexity of the algorithm and resource requirements.

In one or more examples, each state group of the trellis stores sub-state information: 0 or 2 for even, 1 or 3 for odd. Each state of the trellis maintains a score and a survivor path. The score indicates how well the received signal matches the expected symbol, and the survivor path tracks the sequence of symbols leading to the current state.

In one or more examples, the reduced MLSE uses CSI, including parameters such as Signal-to-Noise Ratio (SNR), Channel Response, Impulse Response, or Channel Memory, without limitation. Additionally or alternatively, in one or more examples, DFE tap values (coefficients used in DFEs) are incorporated to further enhance performance by mitigating ISI.

Receivers that perform example reduced MLSE discussed herein performs add-compare-select (ACS) operations on fewer transitions, thereby reducing latency and power consumption. Notwithstanding the fewer states, the performance in terms of SER improvement is similar to the traditional MLSE. The reduced complexity makes it feasible to implement MLSE in SerDes systems operating at very high data rates (e.g., 224 gigabits-per-second (Gbps), without limitation), where traditional MLSE might be too resource-intensive.

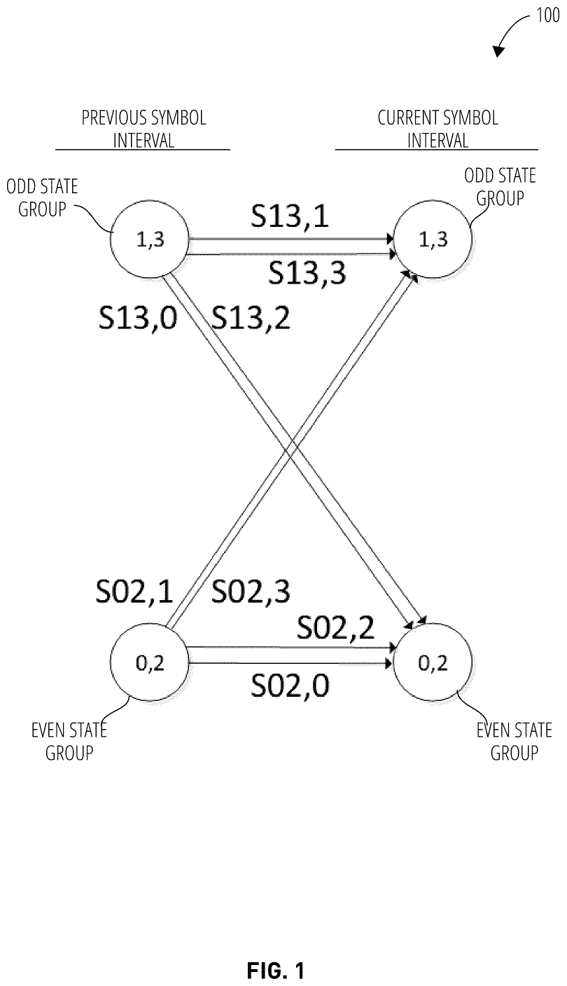

FIG. 1 is a diagram of a reduced trellis structure 100 in accordance with one or more examples.

The trellis diagram depicted by FIG. 1 is a graphical representation of a Finite State Machine (FSM) utilized by a trellis-based decoding algorithm, here, a reduced MLSE algorithm, to determine a most likely transmitted (Tx) sequence of values given a received (Rx) value.

The reduced trellis structure 100 includes a set of nodes (depicted as circles) of a first symbol interval connected by arcs (depicted as arrows) with a set of nodes of a second symbol interval. Each node represents a specific state group, even or odd. Each state group stores sub-state information: 0 or 2 for even, 1 or 3 for odd. Each arc represents a valid transition from the states of a state group of the first symbol interval to states of a state group of the second symbol interval.

Each node of reduced trellis structure 100 maintains (e.g., stores, without limitation) one of the two possible states, and a corresponding score and survivor path of that state. The even state represents the best-fitting symbol (current state) between symbols 0 and 2. The odd state represents the best-fitting symbol (current state) between symbols 1 and 3. The survivor path is the sequence of symbols leading to the current state. The score is the cumulative error score for the survivor path.

In one or more examples, the reduced state MLSE algorithm employs a process to evaluate and discard state and survivor path information that is not needed, each symbol interval.

At each symbol interval, the receiver captures the incoming symbol (the received symbol) and evaluates potential transitions from the previous states. The reduced state MLSE algorithm determines the error (or distance) between the received symbol and the expected symbol for each possible state transition.

For each state group (even and odd), the reduced state MLSE algorithm performs an ACS operation to determine the best-fitting symbol. In the “add” block the reduced MLSE algorithm determines the cumulative score for each transition by adding the current transition error to the previous state's score. In the “compare” block the reduced state MLSE algorithm compares the scores of all possible transitions. In the “select” block, the reduced state MLSE algorithm selects the transition with the lowest cumulative score.

Upon selection of the transition with the lowest cumulative score, the reduced state MLSE algorithm updates the state group with the best-fitting state (0 or 2 for even; 1 or 3 for odd) based on the lowest cumulative score. The reduced state MLSE algorithm update the survivor path to include the current symbol transition. The reduced state MLSE algorithm discards the state and survivor path information for the less optimal transitions.

Notably, PAM4 is particularly suited for the two state trellis because states 1 and 3 and 0 and 2 are easily distinguished since they are generally far enough apart in voltage levels (they are far apart since the DFE tap is large once the channel experiences high insertion loss).

For a given state, each entry in the state's survivor path is a state that represents a single state that may be set to one of two values. Each survivor path has an associated score, and the score is maintained in reduced trellis structure 100.

Maintaining a two-state trellis instead of a four-state trellis reduces complexity, e.g., reduces area, latency, and power consumption.

The two states maintained by the MLSE algorithm {0,2} and {1,3} at any given time only have one value in each state. So, the even state {0,2} is either a 0 or a 2 at a given time and the odd state {1,3} is either a 1 or a 3 at a given time. We filter from four paths coming in to a state down to a single value.

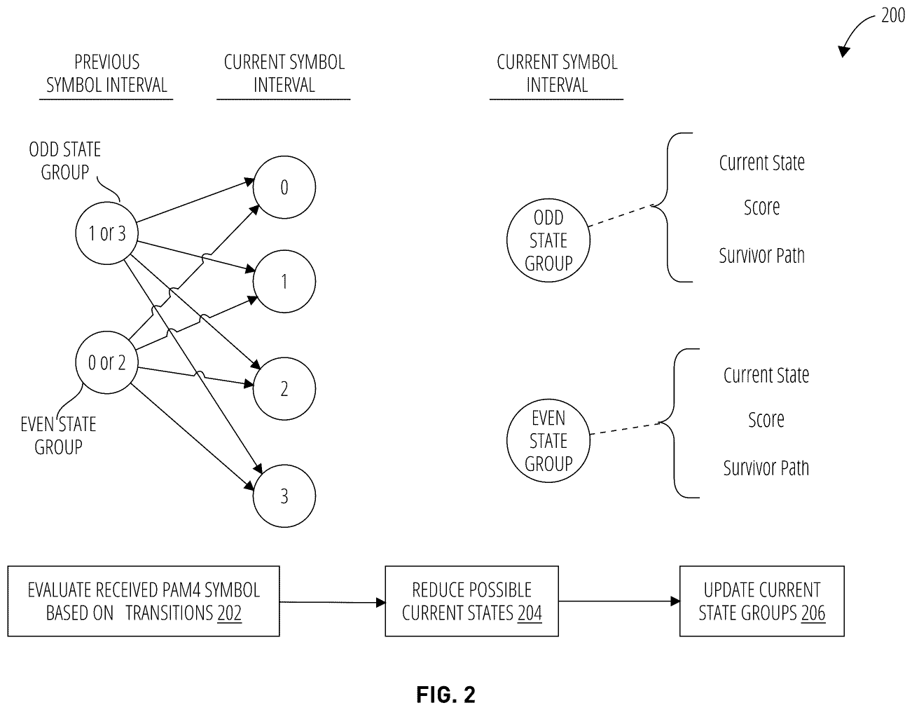

FIG. 2 is a diagram depicting a process 200 to evaluate received PAM4 symbols and how the states of the trellis structure are reduced to a 2:2 configuration, in accordance with one or more examples. The diagram of FIG. 2 is divided into sections that represent the previous symbol interval and the current symbol interval, and it shows the transitions between these intervals.

At the start of process 200, the previous symbol interval has defined state groups (Odd and Even) with initial states (1, 3 for Odd; 0, 2 for Even). A PAM4 symbol is received at the current symbol interval. At an act 202 of FIG. 2, the evaluation process begins by comparing the received PAM4 symbol with the expected symbols for each possible transition from the previous states to the possible current states. For each transition (e.g., from state 0 to state 1 or from state 2 to state 3), the reduced state MLSE algorithm determines the expected symbol and the error (difference or distance) between the received symbol and the determined expected symbols. At an act 204 of FIG. 2, based on the error calculations, the reduced state MLSE algorithm discards transitions where the error is greater than a single signal level. This act effectively reduces the number of possible current states by eliminating unlikely transitions-eliminates expected symbols that are unlikely to be the transmitted symbol due to the magnitude of the distance between them and the received symbol. As a non-limiting example, if the error between the received symbol and the expected symbol for a transition from state 0 to state 3 is greater than one signal level, this transition is discarded.

After discarding unlikely transitions, at an act 206 of FIG. 2, the reduced state MLSE algorithm updates the current state groups with the best possible (e.g., lowest cumulative error) one of respective incoming transitions. For each state group (odd and even), the algorithm selects the incoming transition with the lowest cumulative error score. The current state associated with the selected incoming transition, the corresponding cumulative error score, and the survivor path are updated for respective current state groups. The survivor path is updated to include the sequence of symbols leading to the current state via the selected incoming transition.

The transitions between the previous and current state groups are interdependent. The possible current states depend on the states in the previous interval and the transitions evaluated based on the received symbol.

The error determination directly influences the state reduction process. Only transitions with acceptable error levels (indicative of not more than a single signal level difference) are considered for updating the current states.

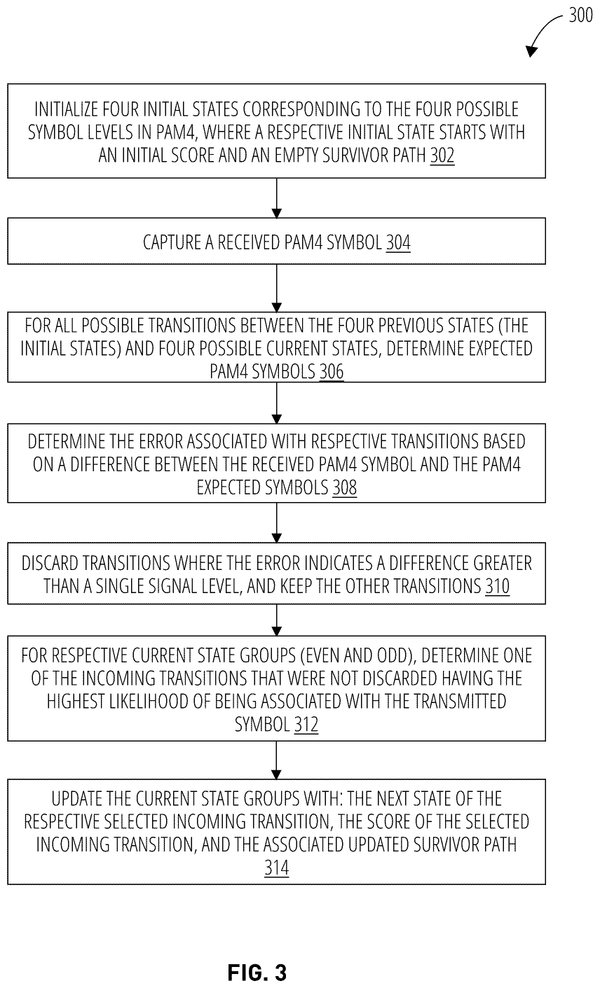

FIG. 3 illustrates an example process 300 to evaluate received PAM4 symbols utilizing reduced state trellis, in accordance with one or more examples. Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to some examples, process 300 may include initializing four initial states corresponding to the four possible symbol levels in PAM4, at operation 302. Respective initial states starts with an initial score and an empty survivor path. Alternatively, in some examples, respective initial states may have a scare and a survivor path determined based on simulated reception of PAM4 symbols.

According to some examples, process 300 may include capturing a received PAM4 symbol at operation 304. The received PAM4 symbol is used to evaluate possible transitions from the previous states.

According to some examples, process 300 may include all possible transitions between the four previous states (the initial states) and four possible current states, determine expected PAM4 symbols at operation 306. The expected PAM4 symbols are predicted symbol values that the PAM4 receiver determines based on previous states and transitions to possible current states. This prediction is derived at least partially based on the survivor path and the known characteristics of the channel to determine what the received symbol should be if the transition is correct. By way of non-limiting example, if the previous state is 0 and the possible current state is 1, the expected symbol is what the receiver anticipates it would see if the transmitted symbol indeed followed this transition.

According to some examples, process 300 may include determining the error associated with respective transitions based on a difference between the received PAM4 symbol and the PAM4 expected symbols at operation 308. The algorithm compares the expected PAM4 symbol with the received PAM4 symbol, and the difference between the received PAM4 symbol and the expected PAM4 symbol is determined.

According to some examples, process 300 may include discarding transitions where the error indicates a difference greater than a single signal level, and keep the other transitions at operation 310. Transitions that would require the received PAM4 signal to deviate significantly from the expected PAM4 signal are considered unlikely (the transition is unlikely to correspond to the actual transition between the last transmitted symbol and the currently transmitted symbol) and are not used in further determinations.

According to some examples, process 300 may include for respective current state groups (even and odd), determine one of the incoming transitions that were not discarded having the highest likelihood of being associated with the transmitted symbol at operation 312. In some examples, process 300 may perform an add-compare-select (ACS) operation to find the most likely transitions as discussed herein.

According to some examples, process 300 may include updating the current state groups with: the next state of the respective selected incoming transition, the score of the selected incoming transition, and the associated updated survivor path at operation 314. In some examples, process 300 may update the current state groups with information about the current state, score, and survivor paths to reflect the selected transitions with the lowest cumulative error.

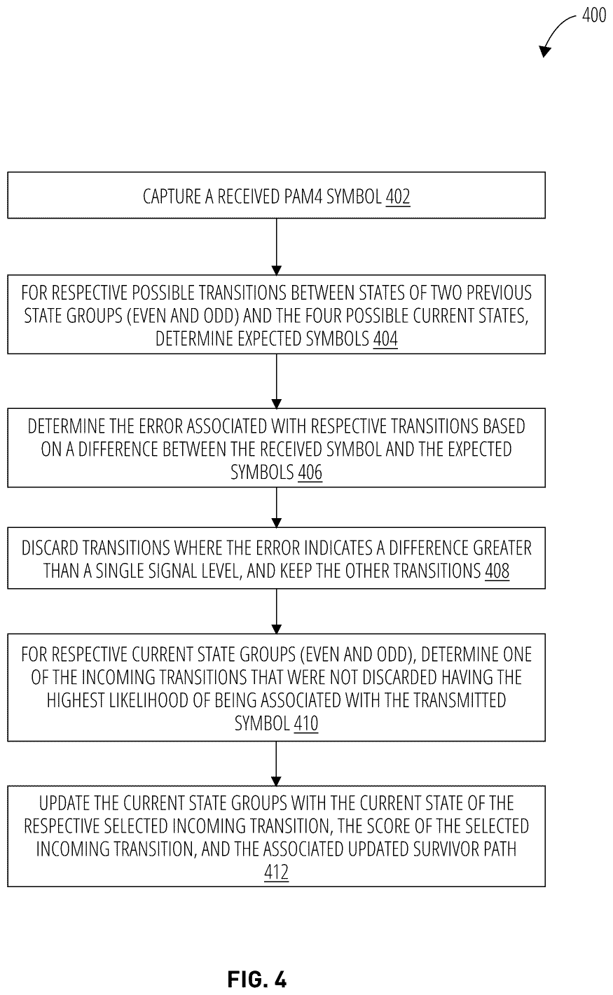

FIG. 4 illustrates an example process 400 to evaluate received PAM4 symbols utilizing reduced state trellis, in accordance with one or more examples. Unlike FIG. 3, which depicted a process that initializes with four states corresponding to the four possible signal levels of PAM4, the example depicted by FIG. 4 assumes the process has been running and starts with a reduced state trellis structure discussed herein.

Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to some examples, the method includes capturing a received PAM4 symbol at operation 402.

According to some examples, the method includes for all possible transitions between states of two previous state groups (even and odd) and the four possible current states, determine expected symbols at operation 404. Here, the reduced MLSE algorithm uses information stored at the previous state groups to determine the expected symbols for all possible transitions. Each of the previous state groups includes a previous state and a corresponding cumulative error score and survivor path, which is the sequence of symbols (or states) that led to the previous state. Notably, process 400 creates, and evaluates transitions to, four possible current states to evaluate transitions from the previous state groups.

According to some examples, the method includes determining the error associated with respective transitions based on a difference between the received symbol and the expected symbols at operation 406.

According to some examples, the method includes discarding transitions where the error indicates a difference greater than a single signal level, and keep the other transitions at operation 408.

According to some examples, the method includes for respective current state groups (even and odd), determine one of the incoming transitions that were not discarded having the highest likelihood of being associated with the transmitted symbol at operation 410.

According to some examples, the method includes updating the current state groups with the current state of the respective selected incoming transition, the score of the selected incoming transition, and the associated updated survivor path at operation 412.

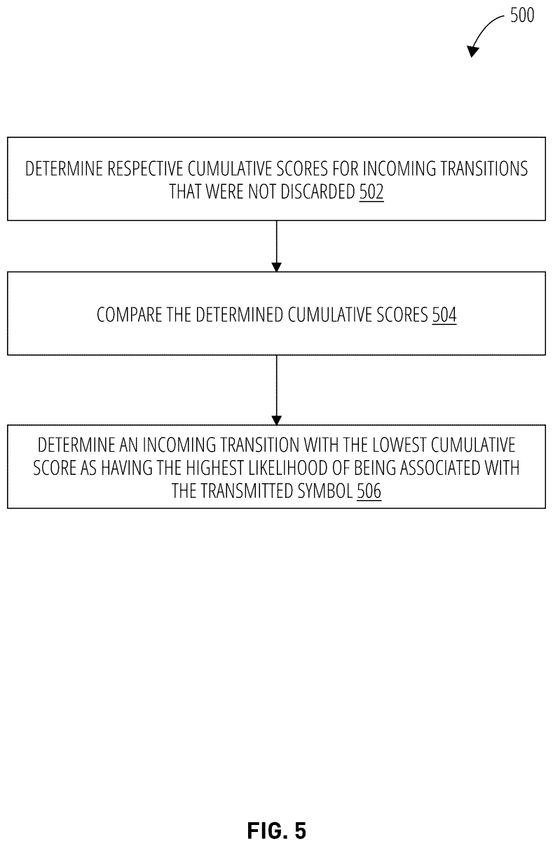

FIG. 5 illustrates an example process 500 for scoring used to determine the best transitions based on cumulative error scores, in accordance with one or more examples. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to some examples, process 500 may include determining respective cumulative scores for incoming transitions that were not discarded at operation 502. This may involve determining the cumulative error scores for each valid transition based on the sum of the current transition error and the previous state's score.

According to some examples, process 500 may include comparing the determined cumulative scores at operation 504. This may involve evaluating all the cumulative scores to identify the most likely transitions.

According to some examples, process 500 may include determining an incoming transition with the lowest cumulative score as having the highest likelihood of being associated with the transmitted symbol at operation 506. This may involve determining the transition with the lowest cumulative error, updating the current state and survivor path accordingly.

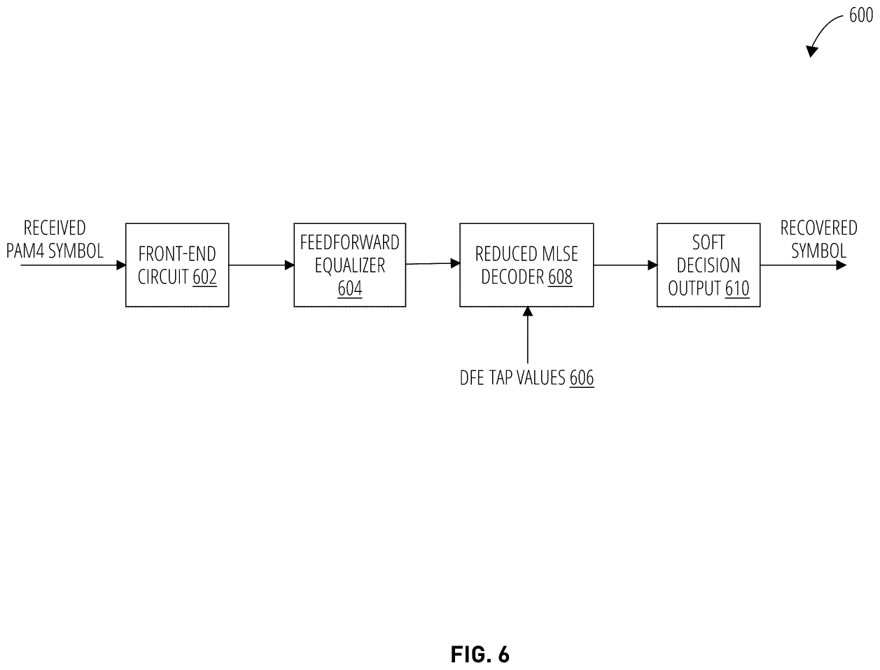

FIG. 6 is a block diagram depicting a signal processing chain 600 of a decoder, in accordance with one or more examples.

The signal processing chain 600 comprises a front-end circuit 602, a feedforward equalizer 604, a DFE tap values 606, a Reduced MLSE decoder 608, and a decision output 610, which, in one or more examples, may be one of the 4 levels available in PAM4 and a survivor path. The survivor path at the output of the MLSE decoder 608 maintains a history of the most likely sequence of PAM4 symbols leading up to any state. The output is selected as the PAM4 survivor path sequence from the lowest score state.

Signal processing chain 600 uses Maximum Likelihood Sequence Estimation (MLSE) and a two-state trellis to decode a PAM4 signal.

The front-end circuit 602 is responsible for capturing the received PAM4 signal from the communication channel. It typically includes analog-to-digital converters (ADCs) to convert the analog signal into a digital format for further processing.

The feedforward equalizer 604 operates in conjunction with MLSE. It compensates for the initial ISI caused by the channel and helps prepare the signal for MLSE decoding. The FFE uses adaptive filters to mitigate channel distortion and enhance the signal quality before passing it to the MLSE decoder.

The Reduced MLSE decoder 608 performs the sequence estimation and data recovery based on the two-state trellis and the DFE tap values 606 (one or more DFE tap values 606).

The MLSE decoder explores multiple paths through the two-state trellis, selects the most probable survivor path, and makes symbol decisions accordingly. It leverages channel state information to calculate the likelihood of different transmitted sequences and optimizes the survivor path to mitigate the effects of noise and ISI.

DFE tap values 606 are an input to reduced MLSE decoder 608 that may be used by the reduced MLSE decoder 608 to determine expected symbols. In one or more examples, a DFE tap value of DFE tap values 606 may be predetermined and set at a DFE tap value input of MLSE decoder 608, or, alternatively, may be a value of a DFE tap of a DFE block of signal processing chain 600 (DFE block not depicted) that is disabled (i.e., is not signal processing) nevertheless a value of a DFE tap was maintained (from when the DFE block was enabled) and provided to MLSE decoder 608.

As a non-limiting example, an apparatus including signal processing chain 600 (e.g., a receiver, without limitation) may offer at least two modes: a DFE only mode and an MLSE mode that utilizes a DFE tap value. When operating according to MLSE mode that utilizes a DFE tap value, the reduced MLSE decoder 608 operates with the benefit of the DFE tap values 606. Alternatively, an apparatus including signal processing chain 600 (e.g., a receiver, without limitation) may offer only one mode, either the MLSE mode or the MLSE mode with DFE tap values.

Traditional DFE compensates for ISI using feedback from previously decoded symbols. The DFE improves the equalization performance by using past decisions to remove or reduce the ISI from the current symbol decisions. DFE tap values 606 represent the degree to which the past decisions influence removal or reduction of ISI from current symbol decisions. In traditional DFE (no MLSE), a 1-time decision is made about a received symbol (e.g., is it the symbol that was transmitted?). That result is used to equalize the next symbol, and then a 1-time decision about the next symbol is made. In traditional DFE, if an error in decision is made then the next symbol decision feedback correction will be wrong, and potentially to a significant degree if the DFE tap is large, e.g., 0.75, without limitation. A DFE tape with a value of 0.75, would generally be characterized as a 75% chance that an error will propagate after a first symbol error, which can lead to very long strings of errors. MLSE maintains multiple paths, where the scoring accounts for the DFE value.

The Reduced MLSE decoder 608 decoder provides decision outputs 610, which are not just binary symbols (0 or 1) but rather probabilities or likelihood values for each symbol. These soft decisions provide more information about the reliability of the decoded symbols, allowing for better error correction and channel decoding.

The output from reduced MLSE decoder 608 is taken from the survivor paths within the engine. The survivor path elements themselves are decided symbols in the set {0,1,2,3}. During MLSE processing the ML survivor path is generated and the winning path is the one with the lowest score (only 2 to pick from).

During operation, as paths are selected or not selected the best paths remain within the engine and those unlikely paths are discarded. Normally, at some distance in to the survivor path the values in either path are the same. All the filtering for this type of channel generally occurs within the first three or four symbols of the survivor path.

The decoded data is finally passed to the application or communication system for further processing or utilization.

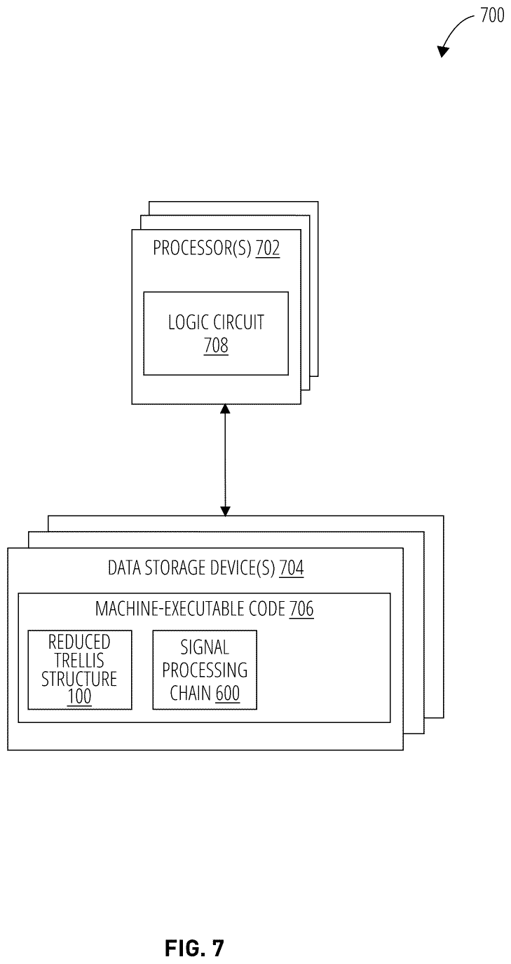

It will be appreciated by those of ordinary skill in the art that functional elements of examples disclosed herein (e.g., functions, operations, acts, processes, or methods) may be implemented in any suitable hardware, software, firmware, or combinations thereof. FIG. 7 illustrates non-limiting examples of implementations of functional elements disclosed herein. In some examples, some or all portions of the functional elements disclosed herein may be performed by hardware capable of carrying out the functional elements.

FIG. 7 is a block diagram of a circuitry 700 that, in some examples, may be used to implement various functions, operations, acts, processes, or methods disclosed herein. The circuitry 700 includes one or more processors 702 (sometimes referred to herein as “processors 702”) operably coupled to one or more data storage devices 704 (sometimes referred to herein as “storage 704”). The storage 704 includes machine-executable code 706 stored thereon and the processors 702 include logic circuit 708. The machine-executable code 706 information describing functional elements that may be implemented by (e.g., performed by) the logic circuit 708. The logic circuit 708 is adapted to implement (e.g., perform) the functional elements described by the machine-executable code 706. The circuitry 700, when executing the functional elements described by the machine-executable code 706, should be considered as special purpose hardware for carrying out functional elements disclosed herein. In some examples the processors 702 may perform the functional elements described by the machine-executable code 706 sequentially, concurrently (e.g., on one or more different hardware platforms), or in one or more parallel process streams.

When implemented by logic circuit 708 of the processors 702, the machine-executable code 706 adapts the processors 702 to perform operations of examples disclosed herein. By way of non-limiting example, the machine-executable code 706 may adapt the processors 702 to perform some or a totality of operations discussed herein to evaluate received PAM4 symbols and how the states of the trellis structure are reduced to a 2:2 configuration, including process 200, process 300, process 400 or process 500.

Also by way of non-limiting example, the machine-executable code 706 may adapt the processors 702 to perform some or a totality of features, functions, or operations disclosed herein. More specifically, features, functions, or operations disclosed herein for one or more of: reduced trellis structure 100, process 200, or signal processing chain 600.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 706 (e.g., software code, firmware code, hardware descriptions) related to examples of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some examples the storage 704 includes volatile data storage (e.g., random-access memory (RAM)), non-volatile data storage (e.g., Flash memory, a hard disc drive, a solid-state drive, erasable programmable read-only memory (EPROM), without limitation). In some examples the processors 702 and the storage 704 may be implemented into a single device (e.g., a semiconductor device product, a system on chip (SOC), without limitation). In some examples the processors 702 and the storage 704 may be implemented into separate devices.

In some examples the machine-executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also by way of non-limiting example, the computer-readable instructions may be stored on the storage 704, transferred to a memory device (not shown) for execution, and executed by the processors 702 using at least the logic circuit 708. Accordingly, in some examples the logic circuit 708 includes electrically configurable logic circuit 708.

In some examples the machine-executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 706 may include an HDL, an RTL, a GL description, a mask level description, other hardware description, or any combination thereof.

In examples where the machine-executable code 706 includes a hardware description (at any level of abstraction), a system (not shown, but including the storage 704) implements the hardware description described by the machine-executable code 706. By way of non-limiting example, the processors 702 may include a programmable logic device (e.g., an FPGA or a PLC) and the logic circuit 708 may be electrically controlled to implement circuitry corresponding to the hardware description into the logic circuit 708. Also by way of non-limiting example, the logic circuit 708 may include hard-wired logic manufactured by a manufacturing system (not shown, but including the storage 704) according to the hardware description of the machine-executable code 706.

Regardless of whether the machine-executable code 706 includes computer-readable instructions or a hardware description, the logic circuit 708 is adapted to perform the functional elements described by the machine-executable code 706 when implementing the functional elements of the machine-executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:
Example 1: A method, comprising: initializing four states of a trellis, the four states corresponding to four possible symbol levels in PAM4, where a respective initial state starts with an initial score and an empty survivor path; for respective possible transitions between the four initial states and four possible current states of the trellis, determining expected PAM4 symbols; determining error associated with respective transitions based on differences between a received PAM4 symbol and the expected PAM4 symbols; discarding transitions where the error indicates a difference greater than a single signal level and keeping the other transitions; and for respective current state groups of a two state trellis, determining one of the incoming transitions that was not discarded having the highest likelihood of being associated with a transmitted symbol.
Example 2: The method according to Example 1, comprising: updating the current state groups with a current state of the respective selected incoming transition, a score of the current state, and an associated updated survivor path of the current state.
Example 3: The method according to any of Examples 1 and 2, wherein the score represents a cumulative error between received PAM4 symbols and expected PAM4 symbols along the survivor path.
Example 4: The method according to any of Examples 1-3, wherein the number of current state groups is less than the number of possible current states.
Example 5: The method according to any of Examples 1-4, comprising: for respective possible transitions between states of two previous state groups of the trellis and four further possible current states of the trellis, determine further expected symbols; determine error associated with respective transitions based on a difference between a further received PAM4 symbol and the further expected symbols; discard transitions where the error indicates a difference greater than a single signal level, and keep the other transitions; for respective current state groups of the two state trellis, determine one of the incoming transitions that was not discarded having the highest likelihood of being associated with a further transmitted symbol; and update the current state groups of the two state trellis with a further current state of the respective selected incoming transition, a score of the further current state, and an associated updated survivor path of the further current state.
Example 6: The method according to any of Examples 1-5, comprising: determining respective cumulative scores for incoming transitions that were not discarded; comparing the determined cumulative scores; and determining an incoming transition with the lowest cumulative score as having the highest likelihood of being associated with the transmitted symbol.
Example 7: The method according to any of Examples 1-6, wherein determining expected PAM4 symbols is at least partially based on one or more decision feedback equalization tap values.
Example 8: An apparatus comprising: at least one processor; and a memory to store instructions that, when executed by the at least one processor, enable the at least one processor to: initialize four states corresponding to four possible symbol levels in PAM4, where a respective initial state starts with an initial score and an empty survivor path; for respective possible transitions between the four initial states and four possible current states, determine expected PAM4 symbols; determine error associated with respective transitions based on differences between a received PAM4 symbol and the expected PAM4 symbols; discard transitions where the error indicates a difference greater than a single signal level, and keep the other transitions; and for respective current state groups of a two state trellis, determine one of the incoming transitions that was not discarded having the highest likelihood of being associated with a transmitted symbol.
Example 9: The apparatus according to Example 8, wherein the memory to store instructions that, when executed by the at least one processor, enable the at least one processor to: update the current state groups in the two state trellis with a current state of the respective selected incoming transition, a score of the current state, and an associated updated survivor path of the current state.
Example 10: The apparatus according to any of Examples 8 and 9, wherein the score represents a cumulative error between received PAM4 symbols and expected PAM4 symbols along the survivor path.
Example 11: The apparatus according to any of Examples 8-10, wherein the number of current state groups is less than the number of possible current states.
Example 12: The apparatus according to any of Examples 8-11, wherein the memory to store instructions that, when executed by the at least one processor, enable the at least one processor to: for respective possible transitions between states of two previous state groups and four further possible current states, determine further expected symbols; determine error associated with respective transitions based on a difference between a further received PAM4 symbol and the further expected symbols; discard transitions where the error indicates a difference greater than a single signal level, and keep the other transitions; for respective current state groups of the two state trellis, determine one of the incoming transitions that was not discarded having the highest likelihood of being associated with a further transmitted symbol; and update the current state groups of the two state trellis with a further current state of the respective selected incoming transition, a score of the further current state, and an associated updated survivor path of the further current state.
Example 13: The apparatus according to any of Examples 8-12, wherein the memory to store instructions that, when executed by the at least one processor, enable the at least one processor to: determine respective cumulative scores for incoming transitions that were not discarded; compare the determined cumulative scores; and determine an incoming transition with the lowest cumulative score as having the highest likelihood of being associated with the transmitted symbol.
Example 14: The apparatus according to any of Examples 8-13, wherein determining expected PAM4 symbols is at least partially based on one or more decision feedback equalization tap values.
Example 15: A system, comprising: a signal processing chain to decode a received signal and recover a transmitted PAM4 symbol; and an MLSE decoder to perform sequence estimation and data recovery at least partially based on a 2:2 trellis.
Example 16: The system according to Example 15, wherein the MLSE decoder to perform sequence estimation and data recovery further at least partially based on a DFE-decision-corrected signal of the signal processing chain.
Example 17: The system according to any of Examples 15 and 16, wherein the DFE-decision-corrected signal of the signal processing chain includes one or more DFE tap values.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
initializing four states of a trellis, the four states corresponding to four possible symbol levels in PAM4, where a respective initial state starts with an initial score and an empty survivor path;
for respective possible transitions between the four initial states and four possible current states of the trellis, determining expected PAM4 symbols;
determining error associated with respective transitions based on differences between a received PAM4 symbol and the expected PAM4 symbols;
discarding transitions where the error indicates a difference greater than a single signal level and keeping the other transitions; and
for respective current state groups of a two state trellis, determining one of the incoming transitions that was not discarded having the highest likelihood of being associated with a transmitted symbol.

2. The method of claim 1, comprising:
updating the current state groups with a current state of the respective selected incoming transition, a score of the current state, and an associated updated survivor path of the current state.

3. The method of claim 2, wherein the score represents a cumulative error between received PAM4 symbols and expected PAM4 symbols along the survivor path.

4. The method of claim 1, wherein the number of current state groups is less than the number of possible current states.

5. The method of claim 1, comprising:
for respective possible transitions between states of two previous state groups of the trellis and four further possible current states of the trellis, determine further expected symbols;
determine error associated with respective transitions based on a difference between a further received PAM4 symbol and the further expected symbols;
discard transitions where the error indicates a difference greater than a single signal level, and keep the other transitions;
for respective current state groups of the two state trellis, determine one of the incoming transitions that was not discarded having the highest likelihood of being associated with a further transmitted symbol; and
update the current state groups of the two state trellis with a further current state of the respective selected incoming transition, a score of the further current state, and an associated updated survivor path of the further current state.

6. The method of claim 1, comprising:
determining respective cumulative scores for incoming transitions that were not discarded;
comparing the determined cumulative scores; and
determining an incoming transition with the lowest cumulative score as having the highest likelihood of being associated with the transmitted symbol.

7. The method of claim 1, wherein determining expected PAM4 symbols is at least partially based on one or more decision feedback equalization tap values.

8. An apparatus comprising:
at least one processor; and
a memory to store instructions that, when executed by the at least one processor, enable the at least one processor to:
initialize four states corresponding to four possible symbol levels in PAM4, where a respective initial state starts with an initial score and an empty survivor path;
for respective possible transitions between the four initial states and four possible current states, determine expected PAM4 symbols;
determine error associated with respective transitions based on differences between a received PAM4 symbol and the expected PAM4 symbols;
discard transitions where the error indicates a difference greater than a single signal level, and keep the other transitions; and
for respective current state groups of a two state trellis, determine one of the incoming transitions that was not discarded having the highest likelihood of being associated with a transmitted symbol.

9. The apparatus of claim 8, wherein the memory to store instructions that, when executed by the at least one processor, enable the at least one processor to:
update the current state groups in the two state trellis with a current state of the respective selected incoming transition, a score of the current state, and an associated updated survivor path of the current state.

10. The apparatus of claim 9, wherein the score represents a cumulative error between received PAM4 symbols and expected PAM4 symbols along the survivor path.

11. The apparatus of claim 8, wherein the number of current state groups is less than the number of possible current states.

12. The apparatus of claim 8, wherein the memory to store instructions that, when executed by the at least one processor, enable the at least one processor to:
for respective possible transitions between states of two previous state groups and four further possible current states, determine further expected symbols;
determine error associated with respective transitions based on a difference between a further received PAM4 symbol and the further expected symbols;
discard transitions where the error indicates a difference greater than a single signal level, and keep the other transitions;
for respective current state groups of the two state trellis, determine one of the incoming transitions that was not discarded having the highest likelihood of being associated with a further transmitted symbol; and
update the current state groups of the two state trellis with a further current state of the respective selected incoming transition, a score of the further current state, and an associated updated survivor path of the further current state.

13. The apparatus of claim 8, wherein the memory to store instructions that, when executed by the at least one processor, enable the at least one processor to:
determine respective cumulative scores for incoming transitions that were not discarded;
compare the determined cumulative scores; and
determine an incoming transition with the lowest cumulative score as having the highest likelihood of being associated with the transmitted symbol.

14. The apparatus of claim 8, wherein determining expected PAM4 symbols is at least partially based on one or more decision feedback equalization tap values.

15. A system, comprising:
a signal processing chain to decode a received signal and recover a transmitted PAM4 symbol; and
an MLSE decoder to perform sequence estimation and data recovery at least partially based on a 2:2 trellis.

16. The system of claim 15, wherein the MLSE decoder to perform sequence estimation and data recovery further at least partially based on a DPE-decision-corrected signal of the signal processing chain.

17. The system of claim 16, wherein the DFE-decision-corrected signal of the signal processing chain includes one or more DPE tap values.
